(19) United States
(12) Patent Application Publication
(10) Pub. No.: US 2008/0202026 A1
(43) Pub. Date: Aug. 28, 2008

(54) Manufacture Method of Block Type Culture Soil Contain Seeds

(76) Inventor: Ryu Bong Kyun, Seoul (KR)

Correspondence Address: WEINER & BURT, P.C., 635 N US-23, POB 186, HARRISVILLE, MI, 48740, US

(21) Appl. No.: 11/914,160

(22) PCT Filed: May 12, 2006
(86) PCT No.: PCT/KR06/01772

§ 371 Date: Nov. 12, 2007

(30) Foreign Application Priority Data
May 16, 2005 (KR) 10-2005-0040433

(51) Int. Cl. A01C 1/04

(52) U.S. Cl. 47/56

(57) ABSTRACT

The invention is about a new Seed Mat Block for plant cultivation and the corresponding construction process. It is a space-saving device and is designed to grow plant in a convenient way, for which users have to do nothing but watering. The invention is characterized by the following features; The Seed Mat Block for plant cultivation consists of a seed mat and a case in which the seed mat is contained. On the seed mat, plant seeds are arranged between the 1st shape mat consisting of uniform-shaped media mat and the 2nd shape mat. Seeing the case, there is an open unit on the top which allows new buds to shoot out of the case, while there is an absorbing unit at the bottom which is designed to supply the seed mat with water from outside and help the seed germination.

### TECHNICAL FIELD

The invention is about a new Seed Mat Block for plant cultivation and the corresponding construction process. It is a space-saving device and is designed to grow plant in a convenient way, for which users have to do nothing but watering.

### BACKGROUND ART

Generally, flower garden or flowerpot is used to grow plants at home. In this case, flower garden or flowerpot takes up some space for its arrangement and installment. Therefore, it is not easy to grow plants using existing flower garden or flowerpot unless the grower has large space at the house.

Moreover, the grower should bring soil and regularly supply water and nutrients to the site when he or she uses flower garden or flowerpot to grow plants. Consequently, the existing methods need burdensome follow-up measures and result in dirty site due to mud or water leaked from the container.

Considering of the weak points set forth, media mat which substitutes for soil was developed previously. The media mat is made of Peat Moss, Coco Peat and Pulp containing nutrients, so that the user could grow plants without any burdensome management except seeding on the mat and watering.

However, even this media mat requires some space more than a certain area for the cultivation, thus it is still restricted by the space required. Actually, the media mat is used for growing young plants of seeds such as rice seeds.

### DISCLOSURE OF INVENTION

### Technical Problem

Accordingly, the invention was created based on the weak points mentioned above. The purpose of the invention is to introduce advanced Seed Mat Block for plant cultivation and the construction process, which is designed to operate without extra space and measure except watering.

### Technical Solution

In order to achieve the 1st technological goal, Seed Mat Block for plant cultivation is characterized by the following features; The Seed Mat Block for plant cultivation consists of a seed mat and a case in which the seed mat is contained. On the seed mat, plant seeds are arranged between the 1st shape mat consisting of uniform-shaped media mat and the 2nd shape mat. Seeing the case, there is an open unit on the top which allows new buds to shoot out of the case, while there is an absorbing unit at the bottom which is designed to supply the seed mat with water from outside and help the seed germination.

In order to achieve the 2nd technological goal, the construction process of Seed Mat Block for plant cultivation is characterized by the following steps; During Step 1, the 1st shape or the 2nd shape mat is made by mean of cutting media mat uniformly. During Step 2, seeds are attached on the 1st shape mat prepared in Step 1. During Step 3, seed mat is constructed by fixing the 1st shape and the 2nd shape mats so that the seeds are arranged between the the 1st shape modified in Step 2 and the 2nd shape mat prepared in Step 1. Lastly, During Step 4, Seed Mat Block is constructed completely by joining the seed mat of Step 3 to the inside of the case, which has an open unit on the top and an absorbing unit at the bottom.

As a result of that, the only thing users have to do is watering and users can grow plants everywhere in a simple way using Seed Mat Block for plant cultivation.

Hereinafter, the illustrations in use are presented.

FIG. 1 illustrates the exterior of the invention, Seed Mat Block for plant cultivation, and the figure shows a plant is growing on Seed Mat Block.

As shown in FIG. 1, Seed Mat Block for plant cultivation is a rectangular parallelepiped standing vertically. Seed Mat Block consists of the seed mat (10) and the case (20) containing the seed mat (10).

Seeing the case (20), there is an open unit (21) on the top which allows new buds to shoot out of the case, while there is an absorbing unit (22) at the bottom which is designed to supply the case (21) inside with water from outside. In FIG. 1, a hinged cover could be applied to the open unit optionally.

Next, the construction process of Seed Mat Block for plant cultivation is described using FIGS. 2 and 3.

First of all, uniform-shaped media mat should be made. In other words, using wooden pattern knife and Tomson machine, the media mat is cut into rectangular shape mats (11), the 1st shape mat (11a) and the 2nd shape mat (11b) (ST1). In order to make the media mat, The media is created by mixing pulp made by dissociating paper such as wastepaper and water. Here, certain material containing peat moss, coco peat, charcoal, moisturizer, anti-fungus agent, zeolite, inorganic matter and adhesives are added at a specific ratio and then the liquid media is formed into a uniform shape with the same area and the same thickness following drying treatment. Instead of the seed mat set forth, generally used mat, vacuum inhalation type media mat for rice, is appliable and neutral mat containing no nutrition is appliable as well in order to increase the germination rate.

Additionally, the shape mats could be modified to have grooves in which plant seed or nutrients agent are injected. The shape mats, for example, are produced by cutting the media mat with grooves, which is formed by the media mat mold with projections. Besides, the wooden pattern knife can be designed to have wooden projections so that the shape mats have grooves when they are cut by the knife.

Then plant seeds are attached to certain points of the 1st shape mat which is previously made during Step 1 using adhesives (Step 2). In this case, plant seeds, plant stems, plant sprouts and roots or bulbs of perennial plants can be regarded as the plant seeds. It is necessary to use proper adhesives which does not disturb plant growth and is excellently water-soluble. It is also desirable to add nutrients (32) necessary for growing plants to specific points of the 1st shape mat (11a), especially beneath the plant seeds (31). The nutrient particles (32) used for the seed mat are fertilizer coated by polymer not affecting the germination but supplying nutrition gradually as a plant grows. The nutrient particles are also produced by settling and drying media mat in water-soluble special asphalt solution whose volatility is removed.

The seed mat (10) is constructed by joining the 2nd shape mat (11b) to the top of the 1st shape mat (11a) containing plant seeds (31) and nutrients (32) (Step 3). In detail, plant seeds (31) and nutrients (32) are arranged between the 1st shape mat (11a) and the 2nd shape mat (11b) as shown in FIG. 3. The seed mat (10) do not have to consist of the 1st shape mat (11a) and the 2nd shape mat (11b) only and it is possible that several shape mats from the 1st to the Nth constitute the seed mat while plant seeds (31) and nutrients (32) are arranged between the shape mats. The 1st shape mat (11a) and the 2nd shape mat (11b) can be fixed by adhesives, adhesive tape or other fix measures. For example of an other measure to fix the 1st (11a) and the 2nd shape mat (11b), they could be fixed by means of using pins or staplers, tying with rope and sawing. At the bottom of the seed mat (10), moisture absorber such as sponge or nonwoven fabric can be placed so that water is effectively absorbed to the seed mat.

Afterward, Seed Mat Block is constructed by assembling the seed mat (10) and the case (20) of Step 3 together (Step 4). Basically, the case (20) prevents the seed mat from transforming due to moisture. Besides, the case (20) keeps the moist air from evaporating from the seed mat (10) and recycles the moisture for germination. Moreover, it stops moisture in the seed mat from rapid evaporating into the air.

FIG. 4 is a development figure to describe the case (20) structure. As shown in FIG. 4, the case consists of front part, side parts connected to the segments of the front part, wing parts which are connected to the segments of the side parts and fix the seed mat by assembling together and cover parts which are connected to the top and bottom segments of the side parts and subject to assemble together, Especially the wing parts are composed of the 1st to the 3rd wing (25a,25b,25c) in order to fix the top, middle and bottom of the seed mat. The 2nd wing (25b) should be longer than the 1st and 3rd wing (25a, 25c) so that it serves as a lumbar to maintain the stable standing of Seed Mat Block. The three wings (25a,25b,25c) and the cover unit have small joining parts (27). The joining parts (27) can be constituted by joining grooves and the corresponding “U” shaped incisions or by incision lines with uniform depth for insert joining.

FIG. 5 to FIG. 8 describe the assembling process. Firstly, the seed mat (10) is placed on the front part (23) inside of the unfolded case (20) as shown FIG. 4. Secondly, the top and the bottom of the seed mat are fixed by connecting the 1st (25a) to the 3rd wing (FIG. 6) and then the cover part (26) of the case (20) is fixed (FIG. 7). Lastly, the 2nd wing (25b) of the case (20) is joined and finally Seed Mat Block is completed (FIG. 8).

Here, a container can be set up on the front of the case (20) as shown in FIG. 9. The container (29) is made of transparent material such as vinyl and its top is open to contain photos or cards. The container (29) is attached to the front part (23) outside of the case (20) by using adhesives like double-sided tape.

In addition, as shown in FIG. 10, Seed Mat Block can be modified so that the seed mat (10) is combined to picture frame-shaped case (40). The case (40) looks like a table picture frame. There is the 1st container (41) on the front to contain a picture and there is the 2nd container (42) on the back of the 1st container (41) to contain the seed mat (10). The lumbar (43) is joined to the back of the 2nd container (42) in order to support the case (20) stably and water unit (44) for water storage is located under the 2nd container (42). There is an absorbing route (45) at the bottom of the 2nd container (42) and the bottom of the 2nd container (42) should be placed at a certain level inside the water unit (44). This is because water in the water unit (44) should be easily delivered to the seed mat (10) through open groove (45) of the 2nd container (42) in case water is supplemented to the water unit (44) while seed mat (10) is in the 2nd container (42).

Additionally, Seed Mat Block is constructed by the following process; the seed mat (10) is inserted into a uniform contractible film envelop and the open is sealed by film joiner. Then, the contractible film is shrunk by heating gun with high temperatures to wrap the surface of the seed mat and the seed mat is joined to the case (51) as shown in FIG. 11. In this case, a certain lumbar (52) is appliable to the back of the case (51) so that the seed mat stands stably. Other than this, Seed Mat Block is also constructed by combining the seed mat (10) and the containable case made of plastics such as polypropylene (PP) and PVC, paper, lumber or steel.

Now, the growing procedures using Seed Mat Block for plant cultivation are to be described.

Firstly, as shown in FIG. 12, users should supply a certain amount of water into the container (B) like a dish, which has some space capable of including Seed Mat Block, and then erect Seed Mat Block in the container (B). The water in the container (B) is delivered to the whole seed mat (10) through the absorbing route (22) of the case (20) due to capillary phenomenon.

The water (W) supplied to the seed mat (10) dissolves the water-soluble adhesives and induces the seed germination after absorbed by plant seeds (23). In addition, water gradually dissolves the surface of nutrient particles coated by polymer through microscopic pores and consequently, nutrition can be continuously supplied to the seed mat. The case (20) keeps the moist air from evaporating from the seed mat (10) and recycles the moisture for germination. Moreover, it stops moisture in the seed mat from rapid evaporating into the air.

In other words, if a certain amount of water (W) is flowed into the seed mat (10) for a certain period, the plant seed begins to sprout out and the plant bud grows out of the case (20). In this case, water circulation caused by transpiration and gravity prevents the seed mat from being rotten.

Thus, using Seed Mat Block which consists of the seed mat containing seeds between shape mats and the case whose top and bottom is partly open, users can grow plants anywhere free from locational constraint.

As we can see the illustration, users can grow plants simply by watering to Seed Mat Block for plant cultivation.

In conclusion, the invention is not limited by the examples above and it is possible for the invention to be modified diversely within the original concept of the invention.

### Advantageous Effects

As described above, the only thing users have to do is watering and users can grow plants everywhere in a simple way using Seed Mat Block for plant cultivation.

### BRIEF DESCRIPTION OF THE DRAWINGS

FIG. 1 shows the exterior of Seed Mat Block for plant cultivation.

FIG. 2 shows the construction process of Seed Mat Block for plant cultivation.

FIG. 3 shows the structure of the seed mat (10) shown in FIG. 2.

FIG. 4 shows the development figure of the case (20) shown in FIG. 2.

FIG. 5 to FIG. 8 show the assembling process of the seed mat (10) shown in FIG. 3 and the case (20) shown in FIG. 4.

FIG. 9 to Drawing 11 show another type of Seed Mat Block for plant cultivation.

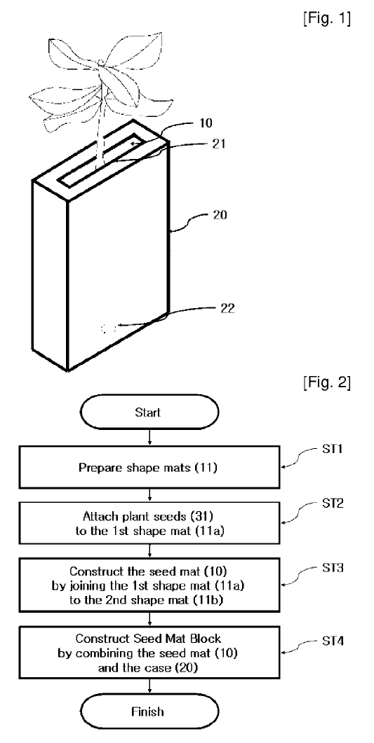

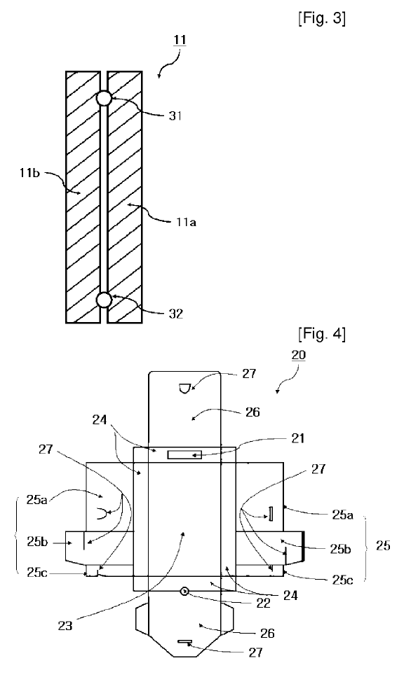

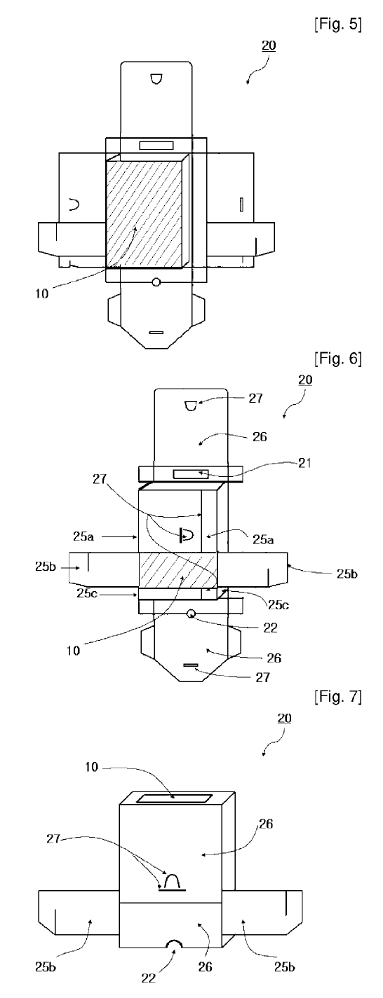

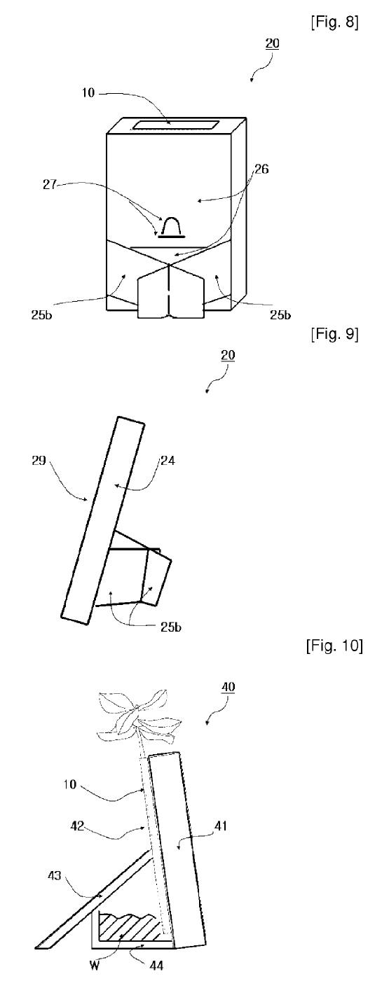

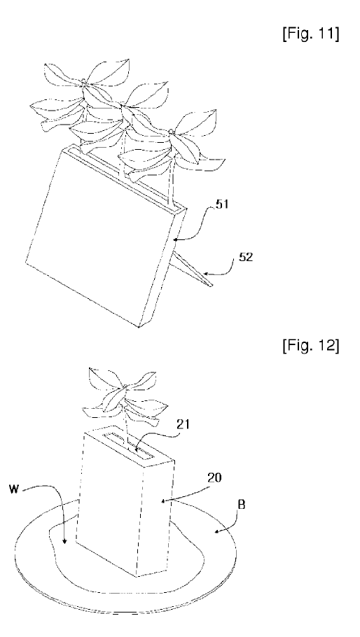

Drawing 12 shows the illustration of Seed Mat Block for plant cultivation.

### Brief Descriptions of Major Parts in Drawings

10: Seed Mat, 11a, 11b: Shape Mat,
20: Case, 21: Open Unit,
22: Absorbing Unit, 23: Front,
24: Side, 25: Wing,
26: Cover, 27 : Joint,
29: Container Unit, 31: Plant Seeds,
32: Nutrients.

### INDUSTRIAL APPLICABILITY

In terms of industrial aspect, the invention is worthful since the only thing users have to do is watering and users can grow plants everywhere in a simple way using Seed Mat Block for plant cultivation.

1-18. (canceled)

19. A seed mat block for plant cultivation, comprising:
a seed mat and a case in which the seed mat is contained;
plant seeds arranged on said seed mat between a first shape mat consisting of an uniform-shaped media mat and a second shape mat;
said case is provided at its top with an open unit which allows new buds to shoot out of the case; and
said case is provided at its bottom with an absorbing unit which supplies said seed mat with water from outside and helps said plant seeds to germinate.

20. A seed mat block according to claim 19, wherein:
said seed mat is formed from liquid media created by mixing pulp made by dissociating paper such as wastepaper, water, and certain material containing peat moss and nutrition in a specific ratio; and
then said liquid media is formed into a uniform shape with uniform area and uniform thickness following a drying treatment.

21. A seed mat block according to claim 19, including:
nutrient particles arranged between said first shape mat and said second shape mat shape beneath said plant seeds.

22. A seed mat block according to claim 21, wherein:
said nutrient particles comprise polymer-coated fertilizer.

23. A seed mat block according to claim 21, wherein:
said nutrient particles are produced by settling and drying said media mat in a water-soluble special asphalt solution whose volatility is removed.

24. A seed mat block according to claim 19, wherein said case includes:
a front part;
side parts connected to segments of said front part;
wing parts which are connected to segments of said side parts and fix said seed mat by assembling together;
cover parts which are connected to top and bottom segments of said side parts for assembly together; and
said wing parts are composed of first to third wings to fix a top, a middle, and a bottom portion of said seed mat.

25. A seed mat block according to claim 24, wherein:
at least one wing of said first to third wings is longer than others of said first to third wings.

26. A seed mat block according to claim 25, including:
a photo unit joined to a front outside of said case, said photo unit for containing a photo.

27. A seed mat block according to claim 26, wherein:
said plant seeds may comprise one or more plant seeds, plant stems, plant sprouts, roots, or bulbs of a perennial plant.

28. A seed mat block according to claim 19, wherein:
said plant seeds may comprise one or more plant seeds, plant stems, plant sprouts, roots, or bulbs of a perennial plant.

29. A seed mat block according to claim 19, wherein:
said case includes a photo unit to contain a photo;
said case includes a seed mat container unit attached to the back of said photo unit to contain said seed mat;
and including:
a supporter joined to a back side of said seed mat container unit;
a water container unit containing supplemental water;
a bottom of said seed mat container unit is placed at a certain level inside said water unit; and
an absorbing unit at said bottom of said seed mat container unit for delivering said supplemented water to inside said seed mat container unit.

30. A seed mat block according to claim 24, wherein:
said case includes a photo unit to contain a photo;
said case includes a seed mat container unit attached to the back of said photo unit to contain said seed mat;
and including:
a supporter joined to a back side of said seed mat container unit;
a water container unit containing supplemental water;
a bottom of said seed mat container unit is placed at a certain level inside said water unit; and
an absorbing unit at said bottom of said seed mat container unit for delivering said supplemented water to inside said seed mat container unit.

31. A method of constructing a seed mat block for plant cultivation, comprising the steps of:
making a first shape mat and a second shape mat by cutting a media mat uniformly;
attaching seeds on said first shape mat;
constructing a seed mat by fixing said first shape mat and said second shape mat so that said seeds are arranged between said first shape mat having said attached seeds and said second shape mat;
completing construction of said seed mat block by joining said constructed seed mat inside a case.

32. A method according to claim 31, including the steps of:
preparing said media mat from liquid media created by mixing pulp made by dissociating paper such as wastepaper, water, and certain material containing peat moss and nutrition in a specific ratio; and
then forming said liquid media into a uniform shape with uniform area and uniform thickness following a drying treatment.

33. A method according to claim 31, including the step of:
attaching nutrient particles on said first shape mat beneath said seeds.

34. A method according to claim 31, including the step of:
forming many grooves on one side of said first shape mat and/or said second shape mat.

35. A method according to claim 34, including the steps of:
using a mold having many projections so that said media mat has many grooves; and
then making said first and second shape mats by cutting said media mat into a uniform shape.

36. A method according to claim 34, including the step of:
cutting said media mat into a uniform shape using a wooden pattern knife having wooden projections so that each said shape mat has grooves when it is produced.

37. A method according to claim 31, wherein said case includes:
a front part;
side parts connected to segments of said front part;
wing parts which are connected to segments of said side parts and fix said seed mat by assembling together;
cover parts which are connected to top and bottom segments of said side parts for assembly together;
said wing parts are composed of first, second and third wings, and said second wing is longer than said first and third wings;
and wherein:
said completing construction step includes putting said seed mat inside said front part of said case, joining said first wing to said third wing, joining said cover parts, and joining said second wing.

38. A method according to claim 37, including the step of:
laminating pile after pile of shape mats from said first shape mat to an Nth shape mat while said seeds are attached between said first and second shape mats.

39. A seed mat block according to claim 19, wherein:
the shape mats from said first shape mat to an Nth shape mat are laminated pile after pile while said seeds are attached between said first and second shape mats.
